(19) United States
(12) Patent Application Publication
(10) Pub. No.: US 2002/0107863 A1
(43) Pub. Date: Aug. 8, 2002

(54) System for and method of learning and automatically correcting business logic errors

(76) Inventor: Neil Hickey, Golden, CO (US)

Correspondence Address: Sam Pasternack, Choate,Hall & Stewart, 53 State Street, Exchange place, Boston, MA, 02109, US

(21) Appl. No.: 09/778,701

(22) Filed: Feb. 7, 2001

(51) Int. Cl. G06F 7/00

(52) U.S. Cl. 707/101

(57) ABSTRACT

A method of and system for automatically handling and correcting business logic errors. The invention employs a trainable user interface computer and application, preferably in a network configuration with an interface computer, a training terminal, a shaper rule set storage device, a format data storage device, a client device, and a host computer, application and storage device. The methodology involves operating existing software applications with a trainable user interface translator system trained to automatically correct business logic errors.

### FIELD OF THE INVENTION

The present invention relates generally to a system for and method of learning and automatically correcting business logic errors. More specifically, the invention monitors and reinterprets data streams associated with one or more existing software applications and, according to rules established during a training sequence, generates response data stream(s) with substituted business data. The invention thus effectively operates the existing application(s) by emulating a user using its normal user interface. The invention has potential application in the field of business software.

### BACKGROUND OF THE INVENTION

Business logic errors are exceptions that occur in the course of performing basic business activity. Often, these exceptions are associated with an error reported by a business application in response to which the user will perform a specific recovery activity. Since business software has become so closely integrated with modem life, access to business software has been made available directly to the customer (e.g. via the Web) and is no longer exclusively operated by trained employees. Therefore, customers encounter business logic errors thousands of times a day when using business software to perform functions such as purchasing goods, reserving tickets, checking inventory, and the like. If these errors are not handled appropriately, they can result in reduced customer satisfaction with a business and even customer loss. In both the business-to-business and business-to-consumer realms of e-commerce, this situation presents a critical need for software that learns and transparently manages business logic errors and minimizes the amount of manual interaction needed to satisfy business functions like order fulfillment and customer inquiries.

E-commerce transactions are increasing at a geometric rate. The market for cutting-edge business software that takes advantage of current network and formatting configurations is currently measured in billions of dollars. Companies involved in expanding the usability, reliability, performance, and longevity of existing business software applications could seize a significant portion of this market. Accordingly, there is sound business motivation to improve the implementation of existing business software.

In existing business systems, when the base application reports an error or exception condition (e.g. “out of stock”), customers must contact suppliers by telephone to fulfill order requests or make inquiries. This can be time consuming and inconvenient for the customer, resulting in the potential loss of the customer. Existing business applications available by Internet typically make only a subset of their products available to the customer, giving the customer only a limited view of what is truly available from the business. Further, outdated systems can be complicated for both the customer and supplier staff to use, resulting in customer loss and reduced productivity. What is needed is a way to improve the performance of business functions and eliminate the manual operations required to deal with exceptions.

Currently, much of the business data surrounding a supplier/customer interaction is inaccessible to a customer because it is not stored within the ordering application. For example, once a customer orders an item from a company, he/she may wish to know the shipping status of the order. Existing business functions forces the customer to contact the supplier, who then provides the shipper's contact information and a tracking number to the customer. The customer must record this information, often on a scrap of paper. The customer must then contact the shipper and provide the tracking number to obtain the needed information. This is time consuming and inconvenient for the customer, and may result in the loss of the customer for the supplier. What is needed is a way to link the computer systems together to provide a single, easy to use, interface to for the customer.

Customers are often unsatisfied with the performance of a business because of delays in handling their requests or because of the inconvenience of having to contact business representatives by telephone during business hours. Frequently, customers may desire information that is readily available on a database that is inaccessible to the customer due to limitations of the existing business software applications. This situation forces customers to spend unnecessary time and money to gain product assistance. What is needed is a way to improve customer satisfaction with a business.

Business logic errors may include, for example, exceptions that occur in the course of utilizing an inventory business application, such as messages to the customer that an item is out of stock, that a part number is invalid, or that an item is available at another location only. When faced with these types of exception messages, the customer often has no recourse for finding an out-of-stock item other than to search the database of another supplier. In the era of e-commerce where multiple suppliers are readily available to the client, this can result in the loss of significant numbers of customers for the supplier who has no means of handling business logic errors. What is needed is a way to automatically correct errors and exceptions that occur in business applications.

The ever-quickening pace of change in the realm of e-commerce, and the business world in general, leaves many business applications obsolete (or at least outdated) in a short amount of time. Outdated applications can result in customer loss because of decreased performance and functionality, and thus customer dissatisfaction with the business. However, creating an entirely new application with increased functionally may be time-consuming and costly to the business. What is needed is a way to extend the life of and improve an existing business application without having to recreate an entire application.

One potential way to solve these problems is to create new applications with similar functionality to the existing business systems. However, this approach is costly, time consuming, and error prone. U.S. Pat. No. 5,857,194 to Kelliher, et al. discloses a system that analyzes an existing legacy system, such as a Physician's Office Management System, and automatically extracts, reformats and sends required data to a service company by feeding the legacy system “seed data” and monitoring the legacy system storage device to determine a “raw map” of where and how the seed data is stored. U.S. Pat. No. 5,946,694 to Copeland, et al., discloses a system in which a managed object assembly is used to abstract the business logic of a given system from the system's operational aspects or infrastructure-specific characteristics. These systems do not have the capabilities of reinterpreting and reformatting data streams, programmatically correcting business logic errors and exceptions, and being able to be trained to handle normal operation and exceptions within existing applications. Thus, there continues to be a need for a system capable of achieving these objectives.

### SUMMARY OF THE INVENTION

The present invention is a system for and method of learning and automatically correcting business logic errors. The system is able to monitor and reinterpret data streams associated with one or more existing applications and, according to rules established during a training sequence, generate response data stream(s) with substituted business data. The invention thus effectively operates the existing application(s) by emulating a user using its normal user interface. Further, the invention is able to extract the useful business data from the data streams, store this data to temporary or permanent local storage, and combine and reformat this data into updated formats such as HTML, XML, and the like. This reformatted data is then presented to the user. Further, this invention may present the extracted data (optionally combined with data from the user, another application, or temporary or permanent storage) to another application or another aspect of the first application. Similarly, the data entered by a user via the newly constructed formats (again, optionally combined with data previously entered by the user, or data obtained from other sources) may be inserted into the generated response data streams.

The invention is trained to recognize the content patterns occurring within the data stream(s) that are associated with specific business logic errors and exceptions, and how to appropriately operate the existing application(s) to correct these errors and exceptions.

An advantage of the present invention is that it can be quickly implemented with a minimal amount of training. The invention obviates the need to recode existing applications in order to gain increased functionality, and can utilize the existing error checking and error handling functionality in the existing source applications. The invention can easily accommodate changes in the existing source applications, and can support additional client devices with ease. The invention can also continue to use old access methods at the same time as using the updated access methods of the present invention, thereby extending the life of existing computer assets.

In one aspect, the invention comprises a trainable system for automatically handling and correcting business logic errors, comprising a trainable user interface translator computer running a trainable user interface translator application. The trainable user interface translator computer is electrically connected to an interface computer electrically connected to one or more client devices, to a training terminal, and to a host computer operating an existing host application. The electrical connection may be direct or via a network. And the system may also be configured with optional storage devices such as a shaper rule set storage device, a format data storage device, a host storage device and or a remote host storage device.

In another aspect, the invention is a method of training the system to operate an existing software application, and to detect and handle business logic errors, comprising the steps of: defining a transaction; selecting sample data sets; choosing a data set from the selected sample data sets; requesting a starting page; filling in a form with form data; transmitting the form data to the trainable user interface translator computer; reviewing the data and sending the data to one or more host computer(s); sending a response page to the client device; sending sample response data to the trainable user interface translator computer; determining if transaction is complete; and determining if there are additional sample data sets.

In another aspect, the invention is a method of using a trained system to operate an existing software application with automatic correction of business logic errors, comprising the steps of: requesting a starting form; filling in the form and submitting; accessing one or more host applications; transmitting variable data; combining variable data with page format data; and determining if the business process is complete.

### BRIEF DESCRIPTION OF THE DRAWINGS

FIG. 1 is a schematic diagram illustrating a system employed in an embodiment of the present invention.

FIG. 2 is a flow diagram illustrating training process steps of the present invention.

FIG. 3 is a flow diagram illustrating the operation of an existing software application with automatic correction of business logic errors.

### DETAILED DESCRIPTION

Preferred embodiments of the invention will now be described with reference to the accompanying drawings. The teachings of the applicant's U.S. Pat. Nos. 5,627,977 and 5,889,516, directed to a “trainable user interface translator” are herein incorporated by reference. The “TeleShaper” terminology used hereinafter to describe the invention is not limited in function or structure to those functions or structures recited in the applicant's prior patents.

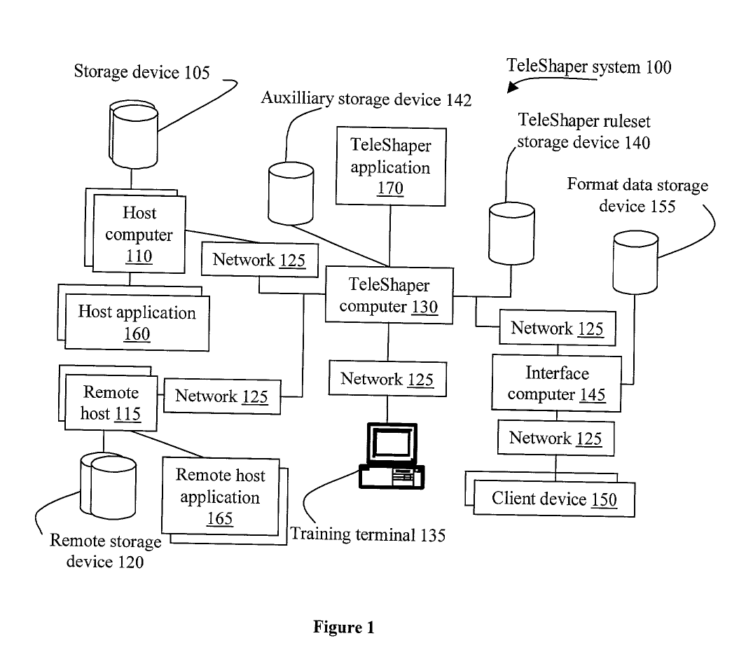

FIG. 1 is a schematic representation of a TeleShaper system 100 that includes numerous optional components. TeleShaper system 100 is comprised of a TeleShaper computer 130, one or more host computer(s) 110, optionally one or more remote host(s) 115, an interface computer 145, a shaper rule set storage device 140, an optional auxiliary storage device 142, a format data storage device 155, one or more client device(s) 150, and a training terminal 135. Host computer 110 is further comprised of a storage device 105 and a host application 160. The remote host 115 is further comprised of a remote storage device 120 and a remote host application 165. The TeleShaper computer 130 is further comprised of a TeleShaper application 170. The TeleShaper system may also preferably include a network 125.

Host computer 110, remote host 115, interface computer 145, and training terminal 135 may connect directly to TeleShaper computer 130 or via a network 125. Network 125 may be an intranet or the Internet. Client device(s) 150 may connect directly to interface computer 145 or via network 125.

In an alternate configuration from that shown in FIG. 1, multiple host computers 110 may connect directly to TeleShaper computer 130 or through network 125. Similarly, multiple remote hosts 115 may connect directly to TeleShaper computer 130 or through network 125.

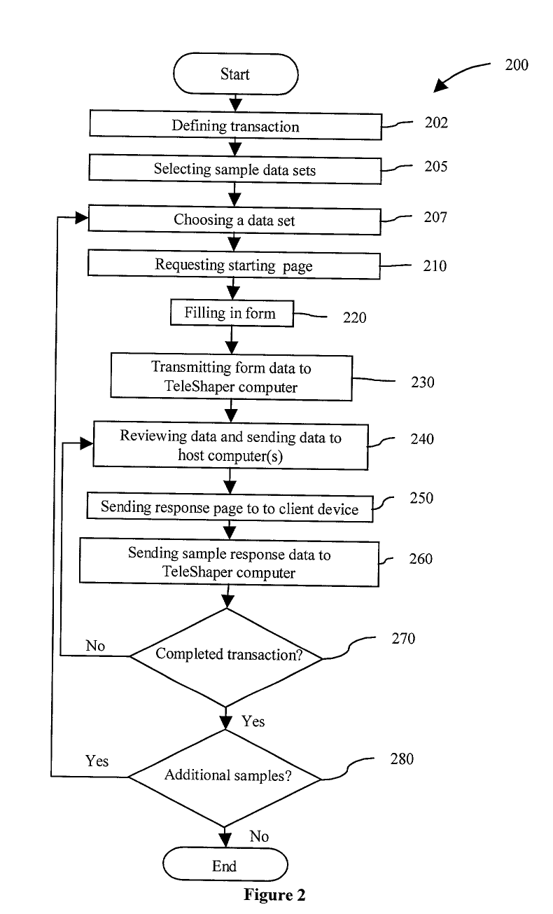

A method of training system 100 to operate an existing software application and to detect and handle business logic errors is now described with reference to FIG. 2.

Step 202: Defining Transaction

In this step, a user decides on the details of a transaction to be designed. This includes the client screens to be utilized, data to be displayed on these screens, data to be obtained from the user via these screens, and a host application operation associated with these data. Using training terminal 135, the user then enters into a TeleShaper rule set a list of pages, including a starting page, along with the name of each page's associated data items. In addition, the static portion of each page is entered onto format data storage device 155 and/or added to the rule set stored.

Step 205: Selecting Sample Data Sets

In this step, the user selects and records a collection of sample input data sets to be used in subsequent steps. The data should include data sets that result in normal operation of the host application(s) as well as sets that cause the error conditions to be automatically corrected. The data sets may be stored on auxiliary storage device 142.

Step 207: Choosing a Data Set

In this step, the user selects one of the sample data sets defined in step 205 for use in operating the system.

Step 210: Requesting Starting Page

In this step, a trainer, using client device 150, requests the starting page of the transaction as defined in step 202. This request is transmitted to interface computer 145, which forwards the request to TeleShaper computer 130. TeleShaper computer 130 responds with the starting page name and variable data, which are combined with the format data for the selected page stored on the format data storage device 155 by the interface computer. The resulting page is then returned to the client device 150.

Step 220: Filling in Form

In this step, the trainer, using client device 150, fills in the requested data in the form contained on the displayed page.

Step 230: Transmitting Form Data to TeleShaper Computer

In this step, the trainer, using client device 150, submits the form data from client device 150. The data is transmitted to the TeleShaper computer 130 via interface computer 145. TeleShaper application 170 then stores the form data locally. The trainer at training terminal 135 is alerted to the fact this form data has been submitted. This begins the training session.

Step 240: Reviewing Data and Sending Data to Host Computer(s)

In this step, the trainer, using training terminal 135, exercises host application 160 and/or remote host application 165. Using training terminal 135 and TeleShaper application 170, the trainer operates the host application 160 and/or remote host application 165 to obtain the needed responses using the form data submitted in step 230 and, optionally, data previously submitted, data stored on auxiliary data storage device 142, and/or data obtained from host application 160 and remote host application 165. The sequence of steps for interacting with these host application(s) (known as the “rule set”) is generated by TeleShaper application 170 and stored on shaper rule set storage device 140.

Step 250: Sending Response Page to Client Device

In this step, the trainer, using training terminal 135, instructs TeleShaper application 170 to send the data and response page name to interface computer 145. Interface computer 145 formats the data and page selection according to format data stored on format data storage device 155 and transmits the data and page request to client device 150. Also in this step, additional elements of the “rule set” are generated by TeleShaper application 170 and stored on shaper rule set storage device 140.

Step 260: Sending Sample Response Data to TeleShaper Computer

In this step, the trainer, using client device 150, fills the next form with sample data and submits the completed form to interface computer 145. Interface computer 145 transmits the completed form to the TeleShaper application 170. TeleShaper application 170 then stores the form data locally. The trainer at training terminal 135 is alerted to the fact this from data has been submitted.

Step 270: Completed Transaction?

In this step, the trainer determines if system 100 is fully trained to complete the transaction defined in step 202. If no, process 200 returns to step 240; if yes, process 200 proceeds to step 280.

Step 280. Additional Samples?

In this step, the trainer determines if there are additional data sample sets selected in step 205 to process. If yes, process 200 returns to step 207; if no, process 200 proceeds to end.

Process 200 terminates after step 280.

The training sequence outlined in process 200 (steps 207 thru 280) is performed for multiple iterations in order to fully train TeleShaper application 170. During the first of these iterations, host application 160 and/or remote host application 165 are exercised and TeleShaper application 170 is trained in the “normal” mode. That is, no errors are produced in the operation of the host application(s) and the TeleShaper software is trained to accommodate routine operation of the host application(s). During the subsequent iterations of the training sequence, the host application(s) are exercised and the TeleShaper software is trained in the “exception” mode. That is, exception data is intentionally introduced during the operation of the host application(s) and appropriate responses are integrated. In this way, TeleShaper application 170 “learns” to transparently process exceptions that occur in the host application(s). During this second phase of training, exception data is entered at steps 220 and 260.

For example, for an inventory program, an exception may occur when a user requests an item that is out of stock at a particular location. TeleShaper application 170 may be trained to return a message to the user that reads “Item Out of Stock.” Alternatively, TeleShaper application 170 may be trained to access and operate an alternate supplier's ordering application 165 via network 125, thus increasing the chances that a user of the system will find the desired item in stock at another location.

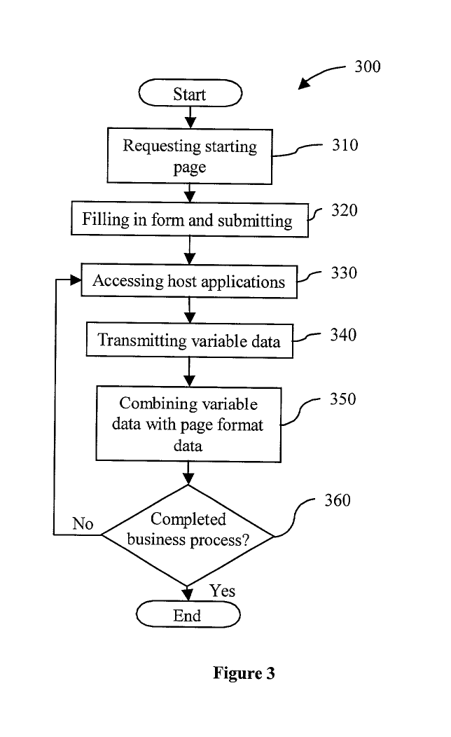

A method of using system 100 to operate an existing software application with automatic correction of business logic errors is now described with reference to FIG. 3. Process 300 presumes that training process 200 has been completed and the results of process 200 have been stored on shaper rule set storage device 140.

Step 310: Requesting Starting Page

In this step, the user, using client device 150, requests the starting page of the transaction. This request is transmitted to interface computer 145, which forwards the request to the TeleShaper computer 130. TeleShaper computer 130 responds with the starting page name and variable data, which are combined with the format data for the selected page stored on the format data storage device 155 by the interface computer. The resulting page is then returned to the client device 150.

Step 320: Filling in Form and Submitting

In this step, the user, using client device 150, fills in the requested information in the starting form and submits the form to TeleShaper application 170 via interface computer 145.

Step 330: Accessing Host Applications

In this step, in response to the form data, TeleShaper application 170 accesses the host application 160 and/or remote host application 165 using the rule set stored on shaper rule set storage device 140. In this way, TeleShaper application 170 responds to exceptions as instructed during the training sequence in process 200.

Step 340: Transmitting Variable Data

In this step, TeleShaper application 170 transmits the variable data obtained by interacting with host application 160 and/or remote host application 175 and/or auxiliary storage device 142 and/or calculated internally to interface computer 145.

Step 350: Combining Variable Data with Page Format Data

In this step, interface computer 145 combines the variable data with the format data for the selected page stored on format data storage device 155 to produce a formatted page. This formatted page is transmitted to client device 150.

Step 360: Completed Business Process?

In this step, the user determines if the business process is completed. If no, process 300 returns to step 330; if yes, process 300 ends.

The invention disclosed herein has the advantage of increasing the functionality of existing applications. The invention has the capability to reinterpret and reformat data streams within and among existing applications, and programmatically correct errors and exceptions within the existing applications. Additionally, the invention can be trained to handle normal operation and exceptions within existing applications. And the invention may be employed in reformatting existing applications' output to an updated appearance.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A trainable user interface translator system for automatically handling and correcting business logic errors within one or more existing applications, comprising:
a first computer operating a trainable user interface translator application and adapted to store a rule set;
an interface computer electrically connected to the first computer and one or more client devices and adapted to store format data;
one or more host computer(s) electrically connected to the first computer and operating one or more existing applications, thereby establishing data streams to and from the interface computer;
a training terminal electrically connected to the first computer for establishing the rule set during a training sequence;
wherein the first computer, according to the rule set established during the training sequence, monitors and reinterprets the data streams, extracts and stores the useful business data from the data streams, and generates response data streams with substituted business data by combining and reformatting the extracted useful business data with the stored format data.

2. The trainable user interface translator system of claim 1, further comprising a rule set storage device electrically connected to the first computer for storing the rule set.

3. The trainable user interface translator system of claim 1, further comprising a format data storage device electrically connected to the interface computer.

4. The trainable user interface translator system of claim 1, further comprising a network for electrically connecting the first computer to the interface computer, one or more host computer(s) and training terminal, and for electrically connecting the interface computer to the one or more client devices.

5. The trainable user interface translator system of claim 1, wherein the one or more host computer(s) includes one or more remote host computer(s) operating an existing remote host application or applications.

6. A method of training a trainable user interface translator system adapted to monitor and reinterpret data streams to operate an existing software application and to detect and handle business logic errors, the trainable user interface translator system comprising a computer operating a training application and adapted to store a rule set and electrically connected to a training terminal, to a host computer operating an existing software application, and to an interface computer electrically connected to a client device, the method comprising the steps of:
defining a transaction at the training terminal;
selecting sample data sets;
choosing a data set from the selected data sets;
requesting a starting page at the client device via the interface computer to the computer operating the training application;
entering form data at the client device into a form returned from the computer operating the training application;
transmitting the form data from the client device via the interface computer to the computer operating the training application;
exercising the existing software application operating on the host computer from the training terminal to obtain needed responses using the transmitted form data and storing a sequence of steps for interacting with the existing software application in the rule set;
instructing from the training terminal a response page to be sent to the client device via the interface terminal which formats the response page and storing additional elements in the rule set;
determining if the trainable user interface translator system is fully trained to complete the transaction, and if not, reverting to the step of exercising the existing software application; and
determining if there are additional selected sample data sets to process, and if so, reverting to the choosing a data set step.

7. The method of claim 6, wherein the sample data sets comprise data sets that result in normal operation of the existing software application as well as data sets that cause error conditions to be automatically corrected, whereby the trainable user interface translator system learns to transparently process exceptions that occur in the existing software application.

8. The method of claim 7, wherein the sample data sets are stored on an auxiliary storage device.

9. The method of claim 6, wherein the interface computer formats the response page by combining format data stored on a format data storage device with starting page name and variable data received from the computer operating the trainable user interface translator application.

10. The method of claim 6, wherein the host computer comprises a remote host computer.

11. The method of claim 6, wherein the trainable user interface translator system further comprises two or more host computers operating existing software applications which are exercised from the training terminal.

12. The method of claim 6, wherein the rule set is stored on a shaper rule set storage device.

13. A method of using a trained user interface translator system adapted to monitor, reinterpret and reformat data streams to operate an existing software application with automatic correction of business logic errors, the trained user interface translator system comprising a trained computer adapted to store a rule set and electrically connected to an auxiliary storage device and to a host computer operating an existing host application and to an interface computer further electrically connected to a client device, the method comprising the steps of:
requesting at the client device a starting form from the trained computer via the interface computer;
filling in at the client device form data into a form returned from the trained computer and submitting the form data to the trained computer;
accessing the existing host application by the trained computer using the stored rule set, thereby responding to exceptions in a manner predetermined during a training sequence;
transmitting to the interface computer variable data obtained by the trained computer by interacting with the existing host application and/or the auxiliary storage device and/or by internal calculation;
combining the variable data with page format data by the interface computer to produce a formatted page; and
determining if the business process is complete, and if not reverting to the accessing step.

14. The method of claim 13, wherein the trained user interface translator system further comprises more than one host computers operating multiple existing host applications, and wherein the trained computer accesses during the accessing step the multiple host applications.

15. The method of claim 13, wherein the host computer comprises a remote host computer.

16. The method of claim 13, wherein the rule set is stored on a shaper rule set storage device.

17. The method of claim 13, wherein the page format data is stored on a format data storage device.
